(19) United States
(12) Patent Application Publication
(10) Pub. No.: US 2011/0242022 A1
(43) Pub. Date: Oct. 6, 2011

(54) Touch Determining Method and Determining Method of Touch Gesture on a Touch Panel

(75) Inventor: Chao-Cheng Wen, Hsinchu Hsien (TW)

(73) Assignee: MSTAR SEMICONDUCTOR, INC., Hsinchu Hsien (TW)

(21) Appl. No.: 12/981,907

(22) Filed: Dec. 30, 2010

Related U.S. Application Data
(60) Provisional application No. 61/319,879, filed on Apr. 1, 2010.

(51) Int. Cl. G06F 3/041

(52) U.S. Cl. 345/173

(57) ABSTRACT

A determining method of touch gesture on a touch panel is provided to avoid misjudgment of determination of a multi-finger touch as a single-finger touch. The method includes determining whether a first valid touch is present on the touch panel; determining whether a second valid touch is present on the touch panel within a predetermined time period when the first valid touch is continuously present within the predetermined time period; generating a first hand gesture instruction when the second valid touch is not detected during the predetermined time period; and generating a second hand gesture instruction when the second valid touch is detected within the predetermined time period.

### CROSS REFERENCE TO RELATED PATENT APPLICATIONS

This patent application claims priority from U.S. Provisional Patent Application No. 61/319,879, filed on Apr. 1, 2010, entitled “Touch Determining Method and Touch Gesture Determining Method Panel”, and incorporates the provisional application in its entirety by reference.

### TECHNICAL FIELD

The present disclosure relates to a touch determining method, and more particularly, to a touch determining method for determining a hand gesture touch and a valid touch on a touch panel.

### BACKGROUND OF THE PRESENT DISCLOSURE

FIG. 1 is a flow chart of a conventional touch determining method. In Step 120, capacitance values of a plurality of capacitive sensors on a touch panel are detected. During a cycle, all capacitive sensors on the touch panel are periodically scanned and recorded. In Step 140, within a predetermined time period, it is determined whether a valid single-finger touch is present on the touch panel according to the capacitance values and a threshold value. When one or more than one of the capacitance values is larger than the threshold value, it is determined that the single-finger touch is present. When the single-finger touch is continuously present within the predetermined time period, it is determined that the single-finger touch is a valid single-finger touch. Otherwise, when none of the capacitance values exceeds the threshold value, it is determined that no single-finger touch is present. Alternatively, when the single-finger touch is not continuously present within the predetermined time period, it is also determined that no valid single-finger is present.

However, due to fast hardware scan speed, errors occur when the conventional single-finger touch method is applied to determine a dual-finger touch. For example, assume that a user tries to touch the touch panel with two fingers, however the hardware first detects a single-finger touch then and a dual-finger touch is then detected because of fast hardware scan speed, thus, erroneous instructions are performed via hardware even if the user feels himself simultaneously touches the touch panel with his two fingers. More specifically, when the single-finger touch is detected via hardware, an instruction corresponding to the single-finger touch is immediately executed; however, the user in fact wishes to perform the dual-finger touch, such that operations of the user are undesirably affected.

Therefore, a determining method for detecting a dual-finger touch is need to avoid error instructions executed by hardware due to misjudgment of determining the dual-finger touch as a single-finger touch

### SUMMARY OF THE PRESENT DISCLOSURE

One object of the present disclosure is to provide a touch determining method of touch gesture on a touch panel to determine the number of valid touches on a touch panel to decide if it is a single-finger touches, a dual-finger touch or a multi-finger touch according to the number of the valid touches, so as to avoid undesirabe instructions caused by misjudging a multi-finger touch as a single-finger touch. The touch determining method is for determining whether a valid touch group is present.

According to an embodiment of the present disclosure, a determining method of touch gesture on a touch panel comprises determining whether a first valid touch is present on the touch panel; determining whether a second valid touch is present during a predetermined time period when the first valid touch is continuously present within the predetermined time period; generating a first hand gesture instruction when the second valid touch is not detected within the predetermined time period; and generating a second hand gesture instruction when the second valid touch is detected within the predetermined time period.

According to another embodiment of the present disclosure, a touch determining method applied to a touch panel comprises receiving a plurality of detection values from the touch panel; respectively determining whether the detection values are larger than a first predetermined value to determine a touch group from the detection values; determining a large detection value of the touch group; determining whether the large detection value is larger than a second predetermined value; and determining the touch group as a valid touch group when the large detection value is larger than the second predetermined value.

According to yet another embodiment, a touch determining method applied to a touch panel comprises receiving a plurality of detection values from the touch panel; respectively determining whether the detection values are larger than a first predetermined value and determining a touch group from the detection values; accumulating the detection values of the touch group to generate an accumulated value; determining whether the accumulated value is larger than a second predetermined value; and determining the touch group as a valid touch group when the accumulated value is larger than the second predetermined value.

According to still another embodiment, a touch determining method applied to a touch panel comprises receiving a plurality of detection values from the touch panel; respectively determining whether the detection values are larger than a first predetermined value; detecting a trend in a part of detection values larger than the first predetermined value to determine a first detection value, a second detection value and a third detection value from the part of detection values larger than the first predetermined value, with a first touch group being determined according to the first detection value and the second detection value, and a second touch group being determined according to the second detection value and the third detection value; and respectively determining whether the first touch group and the second touch group are valid touch groups to determine a valid touch group number.

A method for determining a multi-finger touch is provided according to the present disclosure to avoid misjudgment of determining the multi-finger touch as a single-finger touch thereby creating error instructions.

The advantages and spirit related to the present disclosure can be further understood via the following detailed description and drawings.

### BRIEF DESCRIPTION OF THE DRAWINGS

FIG. 1 is a flow chart of a conventional touch determining method.

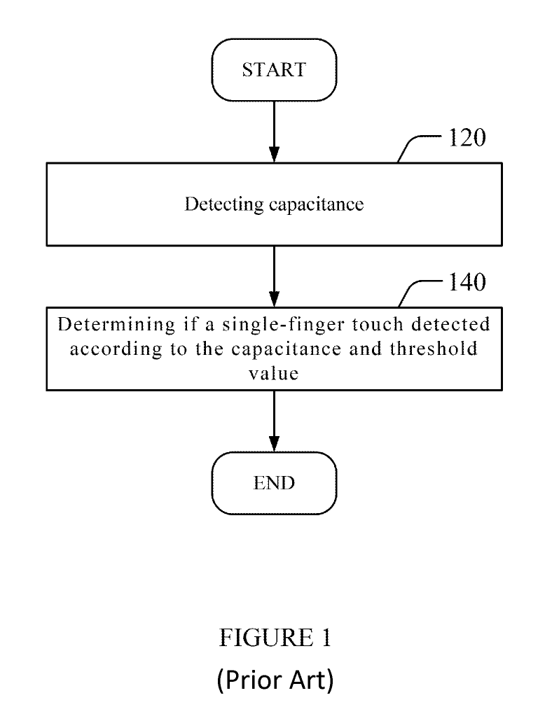

FIG. 2 is a schematic diagram of transformation of touch statuses in accordance with an embodiment of the present disclosure.

FIG. 3 is a schematic diagram of transformation of sub-statuses of touch confirming statuses according to the embodiment illustrated in FIG. 2.

FIG. 4 is a flow chart of a touch determining method in accordance with another embodiment of the present disclosure.

FIG. 5 is a schematic diagram of detection values of a touch group according to the embodiment illustrated in FIG. 4.

FIG. 6 is a flow chart of a touch hand gesture determining method in accordance with an embodiment of the present disclosure.

FIG. 7 is a flow chart of a touch determining method in accordance with yet another embodiment of the present disclosure.

FIG. 8 is a schematic diagram of detection values of a dual-touch group illustrated in FIG. 7.

FIG. 9 is a flow chart of a touch determining method in accordance with still another embodiment of the present disclosure.

FIG. 10 is a schematic diagram of detection values of a touch group illustrated in FIG. 9.

FIG. 11 is a block diagram of functions of a touch coordinate determining apparatus in accordance with an embodiment of the present disclosure.

### DETAILED DESCRIPTION OF THE PREFERRED EMBODIMENT

Nowadays as a touch panel has been more and more widely applied in electronic products, e.g., mobile phones, personal digital assistants (PDAs), flat panel computers and digital televisions (TVs). A user interface of the touch panel becomes more complicated and diversified. Conventional single-finger touch control method no longer meets requirements of a user or a program designer, and a dual-finger or a multi-finger touch control method is in need.

An embodiment of the present disclosure provides a determining method of a touch gesture on the touch panel to determine number of valid touches on a touch panel; and further determine whether a single-finger touch, a dual-finger touch or a multi-finger touch is performed according to the number of valid touches. The method can avoid execution of erroneous instructions due to misjudgment of touch. The touch determining method comprises determining whether valid touch groups are present. It is to be noted that, various types of approaches for determining the valid touch groups are applied to the touch determining method provided by the present disclosure, and it shall not be construed as limiting the present disclosure.

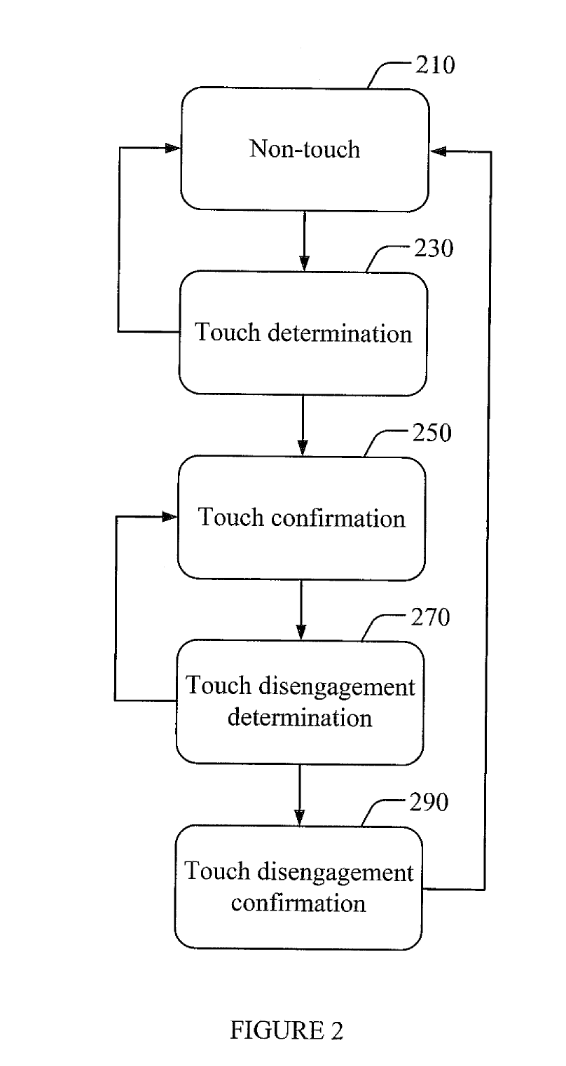

FIG. 2 shows a schematic diagram of flow of touch statuses in accordance with an embodiment of the present disclosure. In this embodiment, the touch statuses include a non-touch status 210, a touch determining status 230, a touch confirming status 250, a touch disengagement determining status 270 and a touch disengagement confirming status 290.

The non-touch status 210 is an initial status. Upon detecting a touch on the touch panel, the touch determining status 230 is entered. For example, when detection values of the touch panel change, it is determined that at least one touch is present on the touch panel thereby entering the touch determining status 230. In the touch determining status 230, when the touch on the touch panel lasts for a period of time, the touch confirming status 250 is entered; when no touch is present on the touch panel or the touch does not last long enough, the status returns to non-touch status 210.

At status 250 in which the touch is present, the next status to be detected is that when the touch becomes disengaged. When it is determined that the touch disengages, the status 270 follows, in which disengagement of the touch is detected. For example, when it is detected that the touch is disengaged, the status changes from the original status 250 to the touch disengagement determining status 270. In status 270, it is determined whether the touch is continuously present on the touch panel within a predetermined time period. If the determination result is positive, the status 290 is entered; otherwise, when it is confirmed that the touch is not yet disengaged, the status 250 is returned. In the status 290, when it is confirmed that the touch is disengaged, the status 210 is returned.

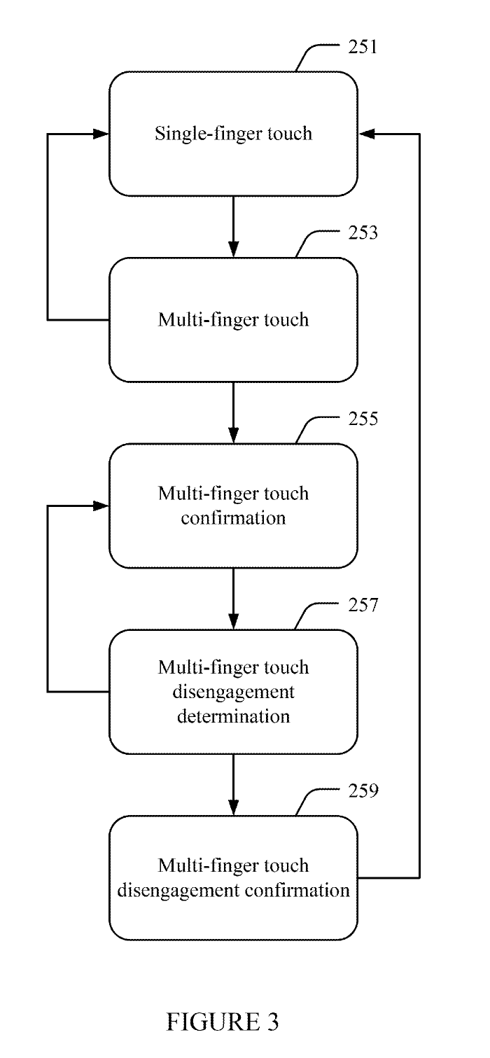

FIG. 3 is a schematic diagram of sub-statuses of a touch confirming status illustrated in FIG. 2 in accordance with an embodiment of the present disclosure. When the touch panel is at status 250 in which the touch is confirmed, it means that at least one touch is present. Then, the number of touch is determined according to the touch confirming sub-statuses in FIG. 3. In this embodiment, the touch confirming status 250 includes five sub-statuses—a single-finger touch status 251, a multi-finger touch determining status 253, a multi-finger touch confirming status 255, a multi-finger touch disengagement determining status 257 and a multi-finger touch disengagement confirming status 259.

An initial status of the touch confirming status 250 is the single-finger touch status 251 that means at least one touch is present on the touch panel. When more than two touches are detected, the flow goes to the multi-finger touch determining status 253. In the status 253, it is determined whether a multi-finger touch is continuously present on the touch panel within a predetermined time period. When the determination result is positive, the status 255 follows, which means the multi-finger touch is confirmed; otherwise, the status turns to the single-finger touch status 251.

Likewise, in status 255, it detecs the multi-finger touch, as well as a time point that the multi-finger touch becomes disengaged. When multi-finger touch is absent, the status flow goes to the multi-finger touch disengagement determining status 257, instead of the non-touch status 210 or the single-finger touch status 251. For example, when the number of touches is reduced in the status 255, the flow goes to the multi-finger touch disengagement determining status 257. More specifically, assume the number of touch originally detected is 2, when the number of touch currently detected is 1, then the flow turns to the touch disengagement determining status 257 in which it is determined whether the number of touches continuously present on the touch panel is reduced within a predetermined time period. When the determination result is positive, the status flow goes to status 259 when it is determined that only one touch is continuously present in the predetermined time period. In the status 259, it is confirmed that the multi-finger touch is disengaged, then the flow goes to status 251. Otherwise, it is determined that the multi-touch has not been disengaged yet, and status flow returns to the status 255.

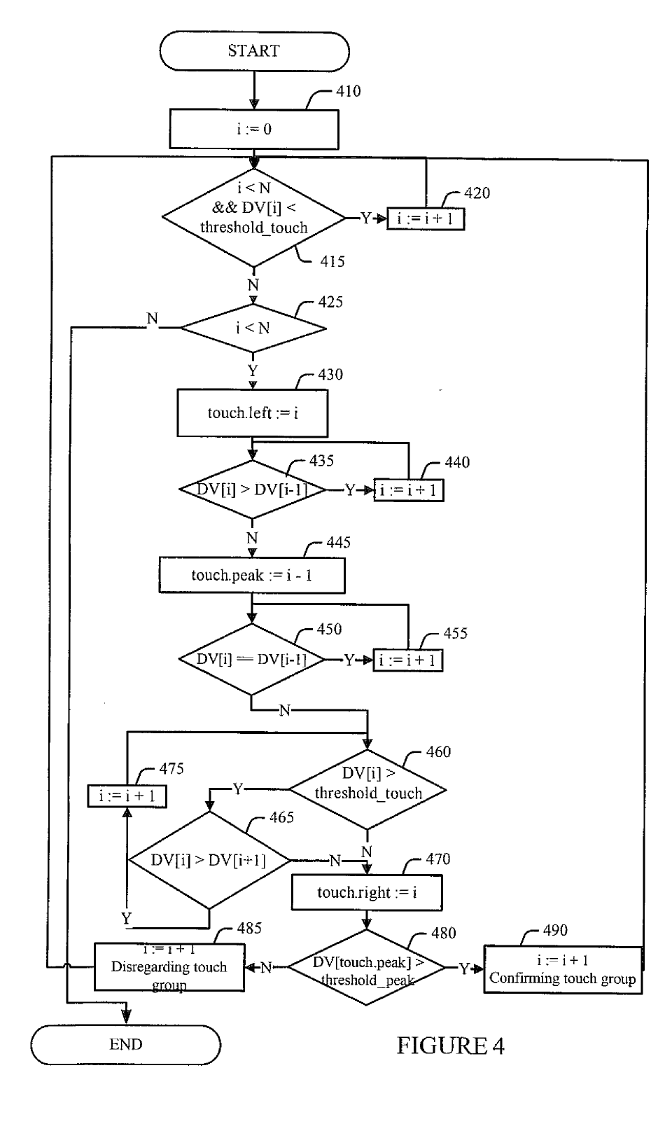

FIG. 4 is a flow chart of a touch determining method in accordance with an embodiment of the present disclosure. The foregoing status flow changes according to the result obtained by performing the touch determining method provided of the present disclosure. For example, assume that the original status is at single-finger touch status 251, the status flow turns to the multi-finger touch determining status 253 when it is detected that two touch groups are present. Furthermore, if the two touch groups are detected for at least 5 times, then the multi-finger touch confirming status 255 is entered; otherwise, when no detection of two touch groups in the multi-finger touch determining status 253, the status returns to the sing-finger touch status 251.

The determination of touch is based on whether valid touch groups are present according to detection values of sensor units on the touch panel. The sensor units may be capacitive sensors or resistance sensors, and the detection values may accordingly be capacitance values or resistance values according to design of the touch panel. Each of the sensor units corresponds to a sensing coordinate SC. In Step 410, variables of the sensing coordinates SC are initialized set as zero, where the maximum value of sensing coordinate SC is N−1.

In Step 415, it is determined whether value of current sensing coordinate SC is smaller than N as well as whether a detection value DV of the current sensing coordinate SC is smaller than a predetermined value ‘threshold_touch’. If the DV is smaller than the threshold_touch, the flow proceeds to Step 420 to increase variable of the current sensing coordinates SC by 1 (one), then continue determining the next sensing coordinate SC. That means, the status flow repeats Step 415. The Step 415 repeats until the variable representing the sensing coordinates SC is equal to N or until the DV value is greater or equal to the predetermined value threshold_touch, which means determination flow of sensing coordinates SC completes.

When the variable representing the current sensing coordinate SC is not smaller than N, or the detection value DV of the current sensing coordinate SC is not smaller than the touch predetermined value threshold_touch, the flow proceeds from Step 415 to Step 425 to further determine whether the variable representing the sensing coordinate SC itself is smaller than N. When the determination result of Step 425 is negative, where the SC value is not smaller than N, then it means the detection value DV of each of the sensing coordinates SC is smaller than the predetermined value threshold_touch, where no touch group is present, and at this point the touch determining method ends. When the determination result of Step 425 is positive, it means that the detection value DV of the sensing coordinate SC is larger than or equal to the touch predetermined value threshold_touch, therefore the flow proceeds to Step 430 to define the sensing coordinate SC as a first left sensing coordinate ‘touch.left’.

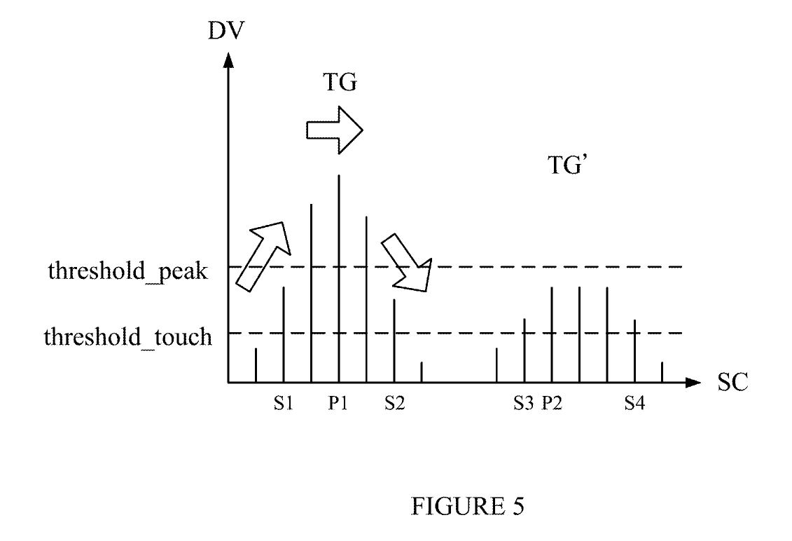

FIG. 5 is a schematic diagram of detection values of a touch group according to the embodiment illustrated in FIG. 4. The foregoing first left sensing coordinate ‘touch.left’, a sensing coordinate SC=S1 shown in FIG. 5, is the sensing coordinate SC which is the first coordinate value larger than the touch predetermined ‘threshold_touch’.

In Step 435, it is determined whether the detection value DV of the current sensing coordinate SC is larger than a detection value DV of a previous sensing coordinate SC. When the determination result of Step 435 is positive, the flow proceeds to Step 440 to increase the variable of sensing coordinates SC by 1 (one) and the flow returns to Step 435. Step 435 repeats until the detection value DV of the current sensing coordinate SC is not larger than that of the previous sensing coordinate SC. When the detection value DV of the current sensing coordinate SC is not larger than that of the previous sensing coordinate SC, the flow proceeds to Step 445 where the previous sensing coordinate SC is defined as a first peak coordinate ‘touch.peak’, i.e., a sensing coordinate SC=P1 shown in FIG. 5.

Step 450 is to determine whether the detection value DV of the current sensing coordinate SC is equal to that of the previous sensing coordinate SC. If yes, the flow proceeds to Step 455 to increase the variable representing the current sensing coordinate SC by one and the flow proceeds back to Step 450. Repeat Step 450 until it is determined that the detection value DV of the present sensing coordinate SC is not equal to that of the previous sensing coordinate SC.

When the detection value DV of the current sensing coordinate SC is not equal to that of the previous sensing coordinate SC, the flow proceeds to Step 460 to determine whether the detection value DV of the current sensing coordinate SC is larger than the touch predetermined value ‘threshold_touch’. When the determination result of Step 460 is positive, the flow proceeds to Step 465 to detect whether the detection value DV of the current sensing coordinate SC is larger than that of the next sensing coordinate SC. If yes, the flow proceeds to Step 475 where the variable representing the sensing coordinates SC is increased by one and then the flow returns to Step 465. Step 460 repeats until it is determined that the detection value DV of the next sensing coordinate SC is not larger than the touch predetermined value threshold_touch.

When the determination result of Step 460 or Step 465 is negative, i.e., when the detection value of the current sensing coordinate SC is not greater than the touch predetermined value threshold_touch, or the detection value of the current sensing coordinate SC is not greater than that of the next sensing coordinate, the flow proceeds to Step 470. In Step 470, the current sensing coordinate SC is defined as a first right sensing coordinate ‘touch.right’, i.e., a sensing coordinate SC=S2 shown in FIG. 5.

In Step 480, it is determined whether a detection value DV[touch.peak] of the first peak coordinate ‘touch.peak’ is greater than a peak predetermined value ‘threshold_peak’. When the determination result of Step 480 is positive, the flow proceeds to Step 490 to confirm that one touch group presents, e.g., the touch group TG shown in FIG. 5, and then increase the variable representing the current sensing coordinate SC by one, then, the flow returns to Step 415 to see whether the detection values DV contain a second touch group. When the determination result of Step 480 is negative, the flow proceeds to Step 485 to disregard the first touch group, and increase the variable representing the sensing coordinate SC by one, and then the flow returns to Step 415, so as to iterate the foregoing steps to determine whether the detection values DV contain other touch groups. Generally, when a user touches the touch panel with his fingers, detection values of sensor units of the touch panel are comparatively large, and one can use a peak predetermined value to decide whether the touch group is a valid touch group. Thus, when both of a maximum detection value and a second maximum detection value of a touch group are smaller than the peak predetermined value, it is reasonable to decide that the variances of detection values of the touch group is due to noise interferences but not a touch.

For example, referring to FIG. 5, when the first peak coordinate P1 is larger than or equal to the peak predetermined value threshold_peak, the first ouch group TG is a valid touch group and variances of detection values is not generated due to noises. In this example, the second touch group TG′ has sensing coordinates SC=S3, S4 and P2, which are respectively a second left sensing coordinate, a second right sensing coordinate and a second peak coordinate. When the second peak coordinate P2 is smaller than the peak predetermined value threshold_peak, the second touch group TG′ is disregarded since it is determined that the variances of the detection values is due to noises rather than a touch.

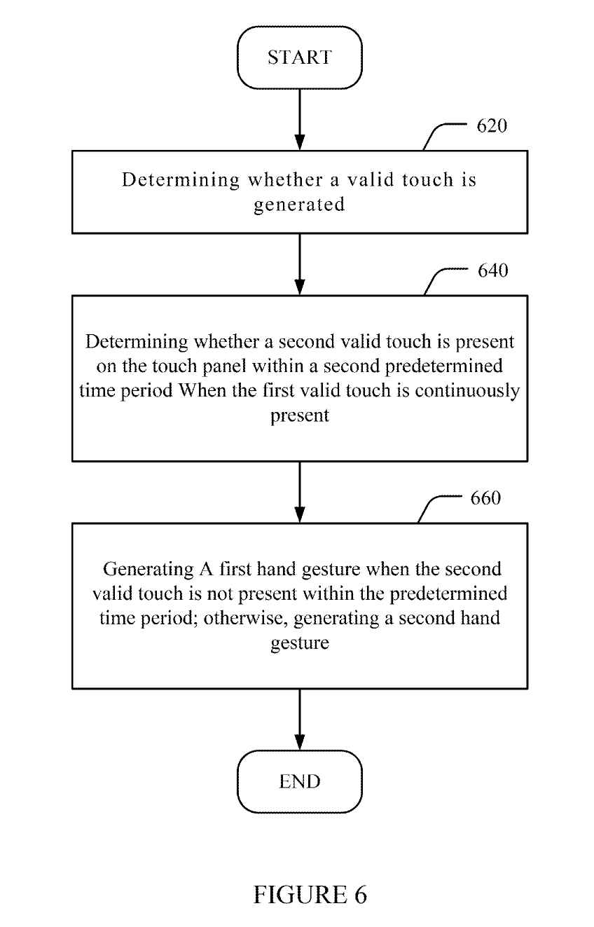

FIG. 6 is a flow chart of a flow chart of determining method for a touch gesture on a touch panel in accordance with an embodiment of the present disclosure. In Step 620, it is determined whether a first valid touch is present on a touch panel. The determining method comprises receiving a plurality of detection values from the touch panel; determining whether the detection values contain a touch group; determining whether the touch group is continuously present during a first predetermined time period; and determining whether a first valid touch is present on the touch panel when the touch group is continuously present during the predetermined time period. A key point of this embodiment is to avoid misjudging a dual-finger touch as a single-finger touch. It is to be noted that, the foregoing touch determining methods disclosed in the foregoing embodiments or other touch determining methods may also be applied to determine whether the first valid touch is present.

In Step 640, when the first valid touch is determined and is continuously present, it is determined whether a second valid touch is present on the touch panel within a second predetermined time period of the first valid touch being determined to be present. That is, when there is no second touch group present on the touch panel after the original touch group is determined within the second predetermined time period. When another touch group is present after the original touch group within the second predetermined time period, it is determined that the second valid touch is present on the touch panel.

In Step 660, when the second valid touch is not present within the predetermined time period, a first hand gesture is generated to indicate the first valid touch as a single-finger touch but not a multi-finger touch, and a single-finger touch coordinate is calculated to perform a corresponding instruction. When the second valid touch is present during the second predetermined time period, a second hand gesture is generated to indicate the first valid touch and the second valid touch as a multi-finger touch but not two single-finger touches, and the multi-finger touch is calculated to perform the corresponding instruction.

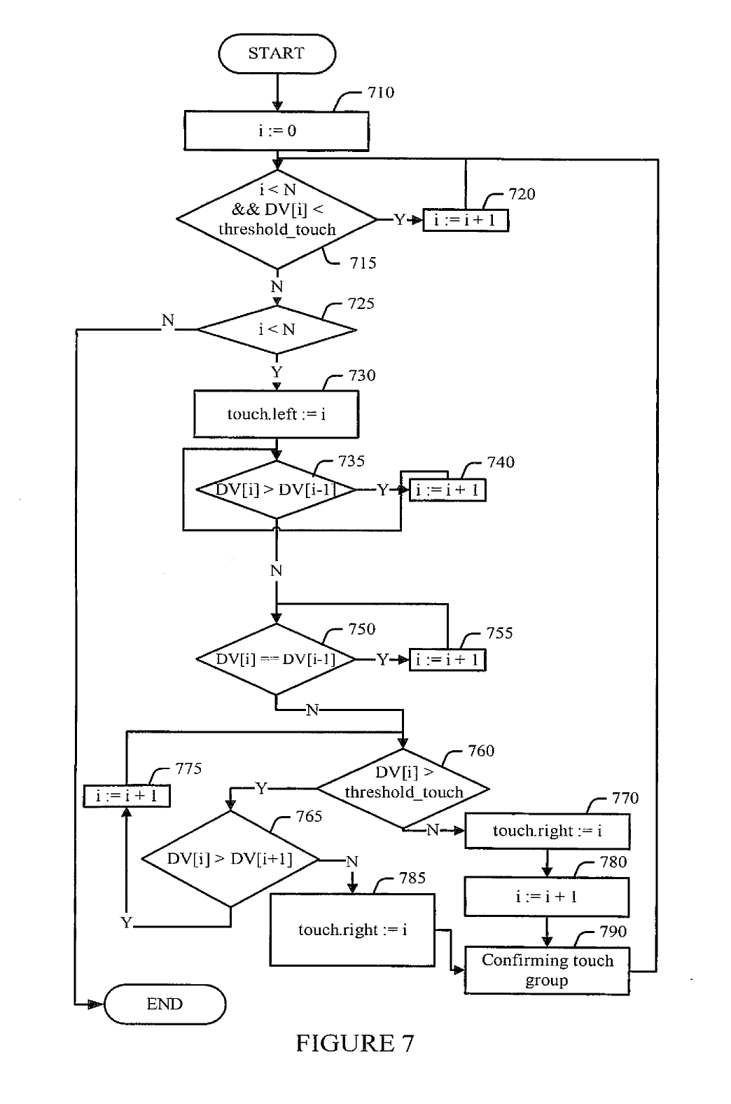

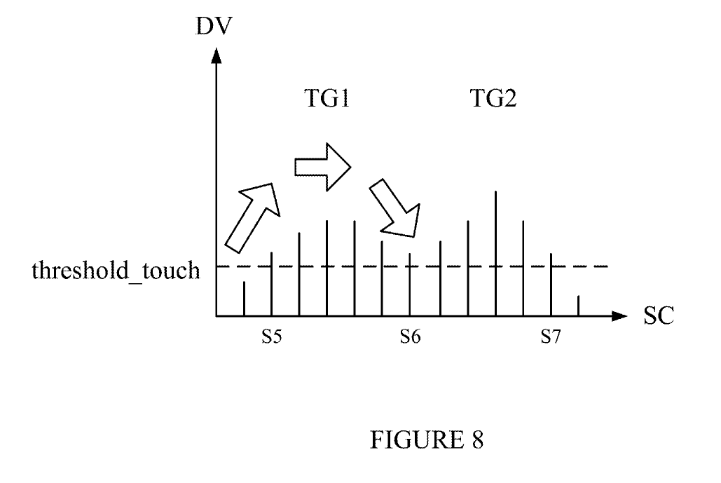

FIG. 7 is a flow chart of a touch determining method in accordance with another embodiment of the present disclosure. FIG. 8 is a schematic diagram of detection values of a dual touch group illustrated in FIG. 7. Referring to FIG. 8, there are two adjacent tough groups TG1 and TG2, i.e., there are no detection values smaller than or equal to the touch predetermined value threshold_touch for the touch group TG1 and the tough group TG2. That is, even if the touch groups are close to each other, under the situation that all of the detection values are larger than the touch predetermined value threshold_touch, two valid touch groups can be identified according to the touch determining method provided by the present disclosure. More specifically, according to the touch determining method provided by the present disclosure, the detection values received from the touch panel are first respectively compared with the touch predetermined value threshold_touch, and a trend of variances of detection values larger than the touch predetermined value threshold_touch, so as to select three comparatively smaller detection values from the detection values that are larger than the touch predetermined value threshold_touch, e.g., detection values corresponding to sensing coordinates S5, S6 and S7. The first touch group TG1 is determined according to the sensing coordinates S5 and S6, and the second touch group TG2 is determined according to the sensing coordinates S6 and S7. After that, it is determined whether the first touch group TG1 and the second touch group TG2 are valid touch groups to determine the number of valid touch groups. Approaches for determining valid touch groups in the foregoing embodiments are also applied to the present embodiment. Steps in this embodiment are similar to those illustrated in FIG. 4, except that Step 445, Step 480 and Step 485 may be skipped, and steps after Step 460 and Step 465 may be respectively performed.

Referring to FIG. 8, the left sensing coordinate and the right sensing coordinate of the first touch group TG1 are respectively S5 and S6, and the left sensing coordinate and the right sensing coordinate of the second touch group TG2 are respectively S6 and S7. Since the touch groups TG1 and TG2 are very close to each other, the right sensing coordinate S6 of the first touch group TG1 is identical to the left sensing coordinate S6 of the second touch group TG2. That is, even if the touch groups are adjacent, in this embodiment, two touch groups, instead of only one touch group, are determined according to an uptrend or a downtrend of variance of the detection values.

In an embodiment, a touch coordinate is calculated according to sensor units in sensing coordinates SC and detection values DV corresponding to the sensor units. For example, a first touch coordinate is calculated according to detection values of sensor units between the first left sensing coordinate S5 and the first right sensing coordinate S6 of the first touch group TG1. Likewise, a second touch coordinate is calculated according to detection values of sensor units between the second left sensing coordinate S6 and the second right sensing coordinate S7 of the second touch group. For example, the first touch coordinate is calculated as

$$\frac{{\sum }_{i = S 5}^{S 6} DV [ i ] * i}{{\sum }_{i = S 5}^{S 6} DV [ i ]}$$

, and the second touch coordinate is calculated as

$$\frac{{\sum }_{i = S 6}^{S 7} DV [ i ] * i}{{\sum }_{i = S 6}^{S 7} DV [ i ]} .$$

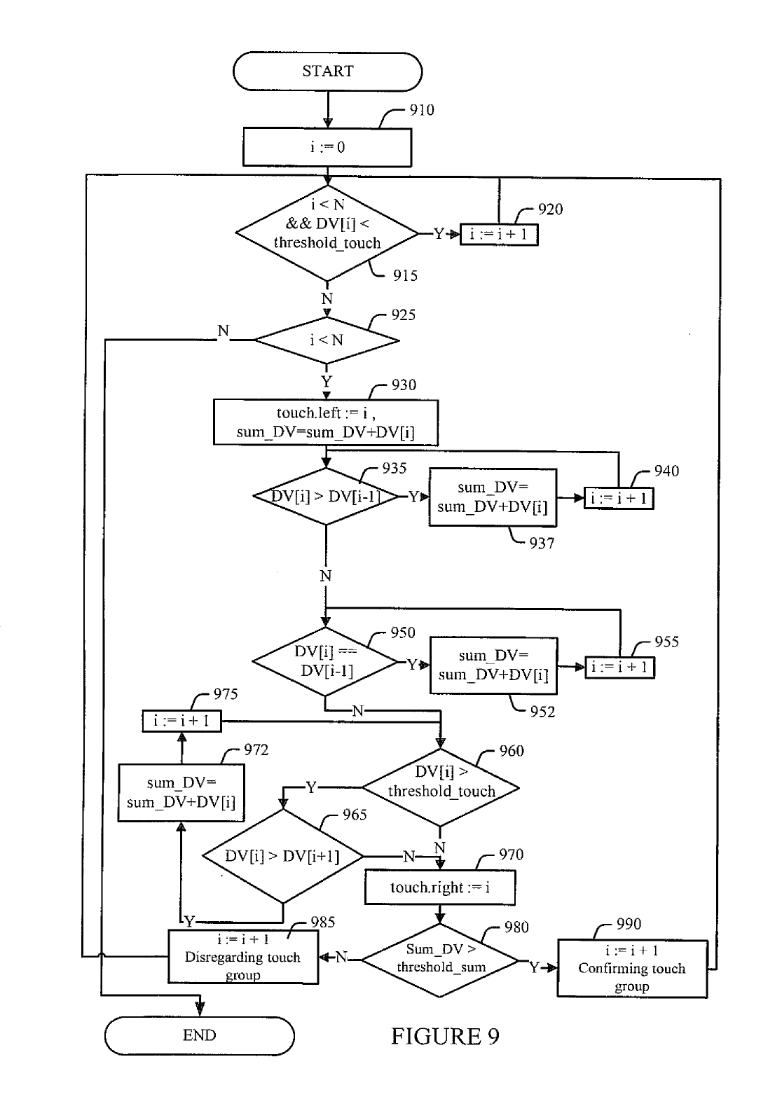

FIG. 9 is a flow chart of a touch determining method in accordance with another embodiment of the present disclosure. Steps in this embodiment are similar to those in the embodiment illustrated in FIG. 4, and a difference is that, in this embodiment, it is determined whether a touch group is valid according to an accumulated detection value sum ‘Sum_DV’ and a predetermined value sum ‘threshold_sum’ rather than the detection value DV[touch.peak] of the peak coordinate and the peak predetermined value threshold_peak as illustrated in FIG. 4.

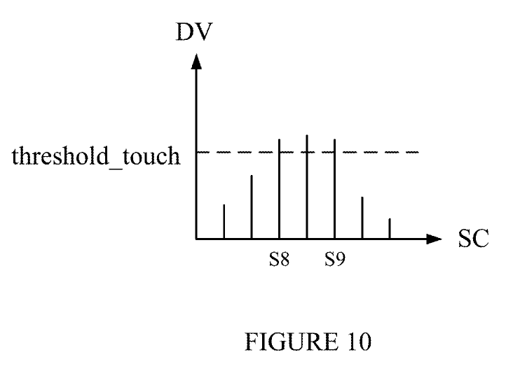

FIG. 10 is a schematic diagram of detection values of a touch group in the embodiment illustrated in FIG. 9. As observed from the flow chart shown in FIG. 9, in Step 970, the left sensing coordinate touch.left is S8, and the right sensing coordinate touch.left is S9 to calculate the detection value sum sum_DV as

$${\sum }_{i = S 8}^{S 9} DV [ i ] .$$

In Step 980, it is determined whether the detection value sum_DV is larger than the predetermined value sum threshold_sum. Although there are three detection values larger than the touch predetermined value threshold_touch in FIG. 10, the detection values are only a little larger than the touch predetermined value threshold_touch. When the detection value sum sum_DV is smaller than or equal to the predetermined value sum threshold_sum, the flow proceeds to Step 985 in which the touch group is disregarded as shown in the schematic diagram of the touch group in FIG. 10, so as to avoid misjudging variances of detection values generated due to noises as a touch.

When the detection value sum sum_DV is larger than the predetermined value sum threshold_sum, the flow proceeds to Step 990 in which the touch group is confirmed. Taking FIG. 5 as an example, five detection values DV between the sensing coordinates S1 and S2 of the touch group TG are accumulated to obtain the detection value sum sum_DV. After that, it is determined whether the detection value sum sum_DV is larger than or equal to the predetermined value sum threshold_sum. When the determination result is positive, it means that the touch group TG is a valid touch group rather than variances generated due to noises. Generally, when a user touches a touch panel with his fingers, it generates comparatively large variances of detection values of sensor units on the touch panel. Therefore, it is determined whether the touch group is a valid touch group by determining whether the detection value sum of the touch group is large enough.

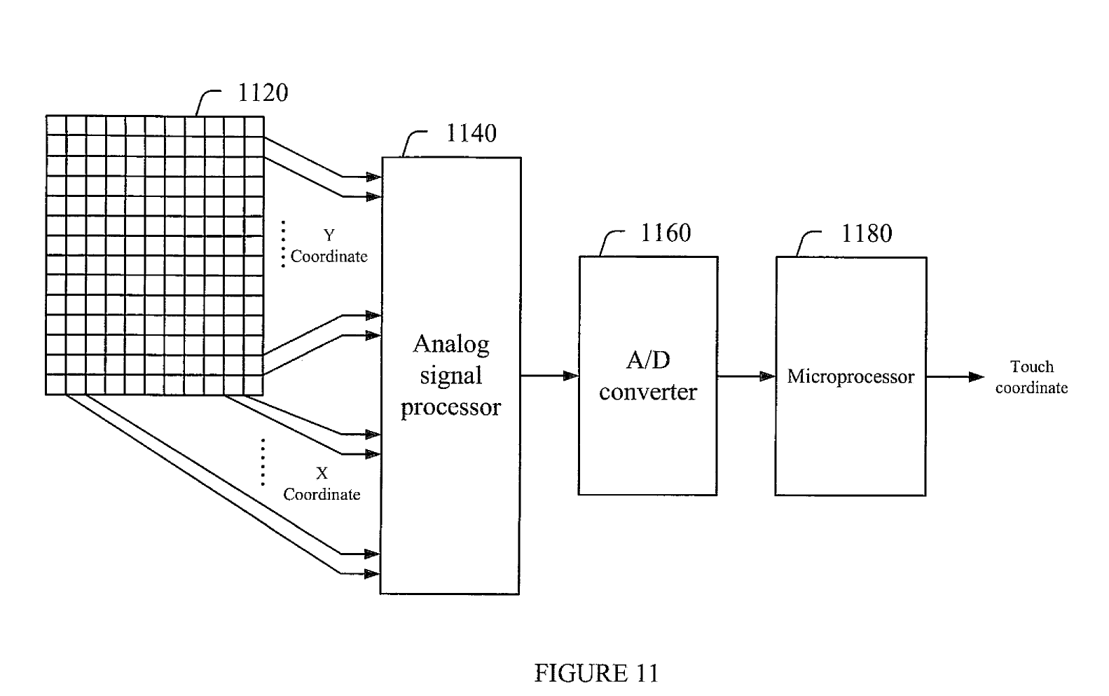

FIG. 11 is a block diagram of functions of a touch coordinate determining apparatus in accordance with an embodiment of the present disclosure. The touch coordinate determining apparatus comprises an analog signal processor 1140, an analog-to-digital converter (ADC) 1160, and a microprocessor 1180.

The analog signal processor 1140 receives a detection value generated by a sensor unit on a touch panel 1120. The sensor unit may be a capacitor or a resistor, and the detection value may be a capacitive value or a resistance value. The detection value is converted to a digital signal via the ADC 1160, and the digital signal is processed via the micro processor 1180 to determine a touch coordinate. The microprocessor 1180 may determine the touch coordinate according to the foregoing touch determining method and the touch hand gesture determining method provided by the present disclosure.

While the disclosure has been described in terms of what is presently considered to be the most practical and preferred embodiments, it is to be understood that the present disclosure needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A determining method for a touch gesture on a touch panel, the method comprising:
determining whether a first valid touch is present on the touch panel;
determining whether a second valid touch is present on the touch panel within a predetermined time period of the first valid touch being determined as present, when the first valid touch is continuously detected; and
generating a first instruction when the second valid touch is determined as not present within the predetermined time period.

2. The method as claimed in claim 1, further comprising generating a second instruction when the second valid touch is determined present within the predetermined time period.

3. The method as claimed in claim 1, wherein determining whether the first valid touch is present on the touch panel comprises:
receiving a plurality of detection values from the touch panel; and
determining whether the detection values contain a touch group.

4. The method as claimed in claim 3, wherein determining whether the first valid touch is present on the touch panel further comprises:
determining whether the touch group is continuously present during another predetermined time period; and
determining the first valid touch is present on the touch panel when the touch group is continuously present during the another predetermined time period.

5. A determining method of a touch on a touch panel, the method comprising:
receiving a plurality of detection values from the touch panel;
respectively determining whether the detection values are larger than a first predetermined value; and
determining a valid touch group according to the detection values.

6. The method as claimed in claim 5, wherein determining the valid touch group comprises:
forming a touch group of the detection values which are larger than the first predetermined value;
selecting a largest detection value from the touch group;
determining whether the largest detection value is larger than a second predetermined value; and
determining the touch group as the valid touch group when the largest detection value is larger than the second predetermined value.

7. The method as claimed in claim 6, wherein determining the valid touch group further comprises disregarding the touch group when the largest detection value is smaller than the second predetermined value.

8. The method as claimed in claim 6, wherein determining the largest detection value of the tough group comprises:
detecting a trend of the detection values of the touch group to determine the largest detection value.

9. The method as claimed in claim 5, further comprising:
forming a touch group by the detection values which are larger than the first predetermined value;
accumulating the detection values of the touch group to generate a SUM;
determining whether the sum is larger than a second predetermined value; and
determining the touch group as the valid touch group when the sum is larger than the second predetermined value.

10. The method as claimed in claim 9, further comprising disregarding the touch group when the sum is smaller than the second predetermined value.

11. The method as claimed in claim 9, wherein determining the touch group as the valid touch group when the sum is larger than the second predetermined value comprises:
determining a largest detection value from the touch group;
determining whether the largest detection value is larger than a third predetermined value; and
determining the touch group as the valid touch group when the sum is larger than the second predetermined value and the largest detection value is larger than the third predetermined value.

12. A determining method of a touch on a touch panel, the method comprising:
receiving a plurality of detection values from the touch panel;
respectively determining whether the detection values are larger than a first predetermined value;
detecting a trend of variances of the detection values, that are larger than the first predetermined value, to determine a first detection value, a second detection value, and a third detection value from the detection values that are larger than the first predetermined value, wherein a first touch group of detection values is determined according to a first detection value and a second detection value, and a second touch group of detection values is determined according to the second detection value and a third detection value; and
respectively determining whether the first touch group and the second touch group are valid touch groups to determine a number of the valid touch groups.

13. The method as claimed in claim 12, wherein determining the number of the valid touch groups comprises:
accumulating the detection values of the first touch group to generate a first sum;
determining whether the first sum is larger than a second predetermined value;
accumulating the detection values of the second touch group to generate a second sum;
determining whether the second sum is larger than the second predetermined value; and
determining the number of the valid touch groups according to a determining result of whether the first sum is larger than the second predetermined value and whether the second sum is larger than the second predetermined value.

14. The method as claimed in claim 12, further comprising:
calculating a first touch coordinate according to detection values between the first detection value and the second detection value; and
calculating a second touch coordinate according to detection values between the second detection value and the third detection value.

15. The method as claimed in claim 12, wherein respectively determining whether the first touch group and the second touch group are valid touch groups to determine the number of the valid touch groups comprises:
selecting a largest detection value from the first touch group to determine the first detection value;
determining whether the first detection value is larger than a third predetermined value;
selecting a largest detection value from the second touch group to determine the second detection value;
determining whether the second detection value is larger than the third predetermined value; and
determining the number of the valid touch groups according to a determining result of whether the first detection value is larger than the third predetermined value and whether the second detection value is larger than the third predetermined value.

16. The method as claimed in claim 12, wherein the first detection value, the second detection value, and the third detection value are relatively small ones among the detection values that are larger than the first predetermined value.
